(19) United States
(12) Patent Application Publication
(10) Pub. No.: US 2011/0082723 A1
(43) Pub. Date: Apr. 7, 2011

(54) RATING AGENTS PARTICIPATING IN ELECTRONIC TRANSACTIONS

(75) Inventors: Guido Governatori, Eveleigh (AU); Subhasis Thakur, Eveleigh (AU); Duy Hoang Pham, Eveleigh (AU)

(73) Assignee: NATIONAL ICT AUSTRALIA LIMITED, Eveleigh (AU)

(21) Appl. No.: 12/572,997

(22) Filed: Oct. 2, 2009

(51) Int. Cl. G06Q 10/00; G06N 5/02; G06F 15/16

(52) U.S. Cl. 705/7.42; 709/202

(57) ABSTRACT

This invention concerns computer system and method for rating agents participating in electronic transactions. In particular, the invention provides a computer system for rating agents participating in electronic transactions, the system comprising a data store to store a set of rules to describe expected behaviours of a first agent for interactions that take place during an electronic transaction with a second agent, wherein at least one rule describes the expected behaviours in terms of a primary expected behaviour and at least one alternative expected behaviour. The system also comprises a monitoring engine operable to monitor actual behaviours of the first agent for interactions that place during the electronic transaction; and a compliance engine operable to calculate a degree of compliance between the monitored actual behaviours and the expected behaviours.

### TECHNICAL FIELD

This invention concerns computer system and method for rating agents participating in electronic transactions.

### BACKGROUND ART

Participants of electronic transactions face the challenge of how to decide whether to trust or not other participants. In user-to-user electronic commerce systems such as Ebay and Amazon (both registered trade marks), users can evaluate the reputation or trust of a particular user based on feedback from other users who had interactions with the user. A limitation of this feedback system is that the feedback provided is highly subjective and usually not justified with quality comments from the users. Further, since the feedback system relies heavily on feedback from human users, it is of little utility to transactions where the participants are computer systems or autonomous agents.

### DISCLOSURE OF THE INVENTION

In a first aspect, the invention is a computer system for rating agents participating in electronic transactions, the system comprising:
A data store to store a set of rules to describe expected behaviours of a first agent for interactions that take place during an electronic transaction with a second agent, wherein at least one rule describes the expected behaviours in terms of a primary expected behaviour.
A monitoring engine operable to monitor actual behaviours of the first agent for interactions that take place during the electronic transaction.
And, a compliance engine operable to calculate a degree of compliance between the monitored actual behaviours and the expected behaviours.

The invention provides a qualitative method to reduce the subjectivity in trust or reputation or rating systems. In particular, by using a set of rules to describe expected behaviours of agents in terms of their primary behaviour, the degree of compliance of an agent can be objectively quantified in terms of the deviation from their primary behaviour. This improves visibility and accountability, in that it is possible to objectively explain the value of a degree of compliance and two equivalent transactions will be given equivalent rating. The invention also reduces reliance on the willingness and availability of agents to provide detailed and justifiable feedback.

There may be at least one rule describes the expected behaviours in terms of a primary expected behaviour and at least one alternative expected behaviour. There may be two rules, each with at least one expected behaviour, that are merged to the corresponding normal form.

The compliance engine may be further operable to:
Match a monitored actual behaviour with a primary or alternative expected behaviour described by one of the rules.
Or to calculate the degree of compliance based on the distance of the matched expected behaviour from the primary expected behaviour.

The expected behaviours may be described using defeasible logic and deontic operators. The expected behaviours may be described as either obligatory, permissible or forbidden using deontic operators.

At least one rule in the set is associated with a weighting factor, and the degree of compliance is calculated based on the weighting factor of the at least one rule.

The set of rules may be divided into a plurality of subsets, each subset representing a metric that contributes to the calculation of the degree of compliance.

The expected behaviours described in the rule may be associated with a weighting factor, and the degree of compliance may be calculated based on the weighting factor of the expected behaviours.

The degree of compliance between the monitored actual behaviours and the expected behaviours may also based on historical performance of the agent.

The monitoring engine may be operable to monitor actual behaviours of the first agent based on log files recorded during the electronic transaction.

The monitoring engine may be operable to monitor actual behaviours of the first agent based on input from the second agent.

The electronic transaction may be an electronic commerce transaction between the agents. Or, a web service interaction between the agents.

At least one of the first and second agents may be computer-operated.

The computer system may further comprise a rules creation engine to provide an interface for agents to define the set of rules prior to an electronic transaction. The set of rules may be created by domain experts prior to the electronic transaction.

It is an advantage of at least one embodiment of the invention that expected behaviours of the agents can be codified in declarative rules using defeasible logic with deontic operators. This facilitates improved visibility and accountability.

It is an advantage of at least one embodiment of the invention to use a declarative representation to model expected behaviour of interacting agents that is simpler to define. The declarative representation is easier to maintain and modify according to changes in the expected behaviour of agents over time. Since the representation is based on a formal contract language, it also facilitates the use of logical techniques to check consistency of the rules specified.

It is an advantage of at least one embodiment of the invention that the degree of compliance of fully autonomous agents can be automatically calculated based on actual behaviour, without any manual feedback from an operator overseeing their operation. For example, an autonomous agent can be in the form of a computer system or web service. Using a set of rules to describe expected behaviour, the nature of the open and unpredictable environment in which the autonomous agents operate in can be taken into account when devising the degree of compliance.

It is an advantage of at least one embodiment of the invention that the chance of collusion among agents to boost, or to spoil, the reputation of some other agents is reduced, if not avoided.

In a second aspect the invention is a computer-implemented method for rating agents participating in electronic transactions, the method comprising:
Monitoring actual behaviours of the first agent for interactions that place during the electronic transaction.
And, calculating a degree of compliance between the monitored actual behaviours and expected behaviours of a first agent for interactions that take place during an electronic transaction with a second agent.
Wherein the expected behaviours are described using a set of rules, and wherein at least one rule describes the expected behaviours in terms of a primary expected behaviour.

### BRIEF DESCRIPTION OF DRAWINGS

An example of the invention will now be described with reference to the accompanying drawings, in which:

FIG. 1 is a schematic diagram of a computer system exemplifying the invention.

FIG. 2 is a flowchart of a computer-implemented method performed by a server in the computer system in FIG. 1.

### DETAILED DESCRIPTION OF THE INVENTION

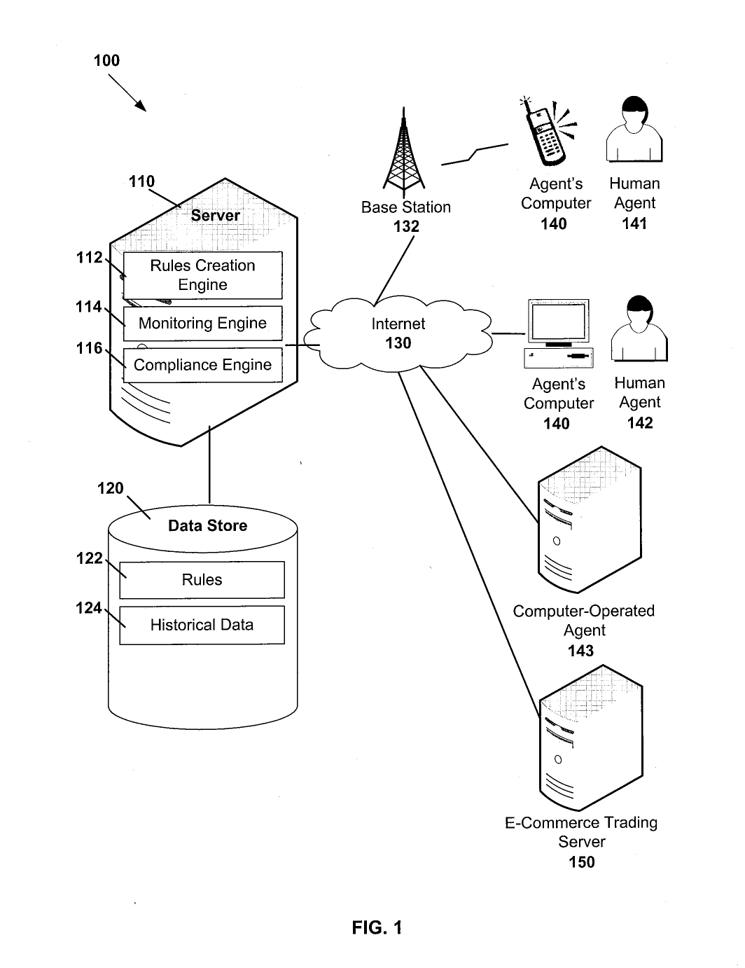

Referring first to FIG. 1, the computer system 100 comprises a server 110 and a data store 120 in communication with a plurality of agents 141, 142, 143 participating in electronic transactions over the Internet 130, and where appropriate, mobile base station 132. The server 110 is also in communication with a plurality of external servers, such as an e-commerce trading server 150 that facilitates e-commerce transactions between the agents.

An agent may a human agent 141 accessing the computer system 100 using any form of computer 140 such as a personal computer (PC), mobile communications device and laptop. The agent 143 may also be computer-operated (only one is shown for simplicity), such as a server 143 providing web services built over Service-Oriented Architecture.

The data store 120 stores a set of rules 122 to describe expected behaviours of agents 141, 142, 143 for interactions that take place during an electronic transaction with other agents 141, 142, 143. The rules can be created by the agents 141, 142, 143 prior to conducting transactions, or by domain experts who are familiar with expected behaviours for business interactions in the domain.

The rules 122 take into account the fact that interactions among agents 141, 142, 143 do not happen in isolation, but these interactions are governed by rules 122. The key point is that all these rules describe (and prescribe) the expected behaviour of an agent 141, 142, 143. Throughout this specification, “rules” that govern the expected behaviour of an agent can be taken in the form of norms, social obligations, contracts, and policies. These terms will be used interchangeably.

As will be explained in detail later, at least one rule in the set describes expected behaviours in terms of a primary expected behaviour and at least one alternative expected behaviour. The primary expected behaviour determines what an agent has to do to be compliant. In cases where the primary expected behaviour is not satisfied, the alternative expected behaviour is still acceptable.

As such, the rules 122 define a range of expected behaviours, in order of preference or compliance level and the degree of compliance is a numeric score specifying the degree of deviation of an agent's behaviour from its primary expected behaviour. The further their expected behaviour deviates from the primary expected behaviour, the lower the degree of compliance is.

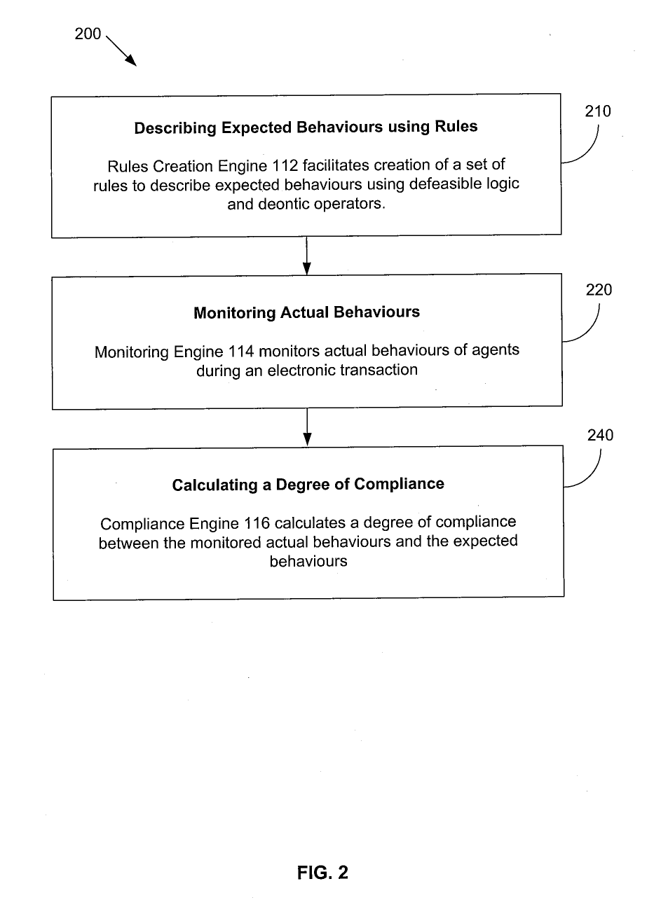

Referring also to the flowchart 200 in FIG. 2, the server 110 comprises the following hardware and software components:
a rules creation engine 112 operable to provide a web interface for agents 141, 142, 143 or domain experts to define the set of rules 122 prior to an electronic transaction; see step 210;
a monitoring engine 116 operable to monitor actual behaviours of the first agent for interactions that place during the electronic transaction; see step 220; and
a compliance engine 118 operable to calculate a degree of compliance between the monitored actual behaviours and the expected behaviours; step 240.

To calculate the degree of compliance, the compliance engine 118 first matches monitored actual behaviours with the expected behaviours described the rules 122. Then, the compliance engine 118 determines the distance of the matched expected behaviour from the primary expected behaviour. The degree of compliance for a rule is calculated based on the determined distance, from which the overall degree of compliance can be calculated.

The steps performed by the rules creation engine 112, monitoring engine 116 and compliance engine 118 will now be described in further detail.

### Rules

Rules 122 describes the expected behaviours of an agent 141 in interactions during an electronic transaction with other agents 142, 143. Formal Contract Language (FCL) [3], which is a combination of an efficient non-monotonic formalism (defeasible logic [1]) and a deontic logic of violations [5], is used for this purpose. This particular combination allows representation of exceptions as well as the ability to capture violations, the obligations resulting from the violations, and the compensation for the violations.

Deontic Logic extends classical logic with the modal operators O, P and F, which represent obligatory, permission and forbidden respectively. For an expected behaviour A, the interpretations for OA, PA and FA are respectively A is obligatory; A is permissible; and A is forbidden.

The modal operators obey the following mutual relationships (where ≡ means equivalent and [symbol] is a negation operator):

(i) OA≡ [symbol] P [symbol] A, i.e. A is obligatory is equivalent to (not A) is not permissible
(ii) [symbol] P [symbol] A≡PA, i.e. (not A) is not obligatory is equivalent to A is permissible
(iii) O [symbol] A≡FA, (not A) is obligatory is equivalent to A is forbidden
(iv) [symbol] PA≡FA, A is not permissible is equivalent to A is forbidden.

The modal operators are also closed under logical equivalence, that is if A≡B then OA≡OB, and satisfy the axiom OA [symbol] PA, that is if A is obligatory, then A is permitted that implies the internal coherency of the obligations in a set of norms. In other words, it is possible to execute obligations without doing something that is forbidden. Thus, obligatory actions are the actions expected to be performed by an agent, while prohibitions describe unacceptable outcomes for an agent.

Rules describing the behaviour of an interaction between agents usually specify actions to be taken in case of breaches of some of the norms in them. These can vary from (pecuniary) penalties to the termination of an interaction itself This type of construction, that is alternative obligations in force after some other obligations have been violated, is known in the deontic literature as contrary-to-duty obligations (CTDs) or reparational obligations. This is because they are activated when normative violations occur and are meant to ‘repair’ or ‘compensate’ violations of primary obligations [2].

Thus, a CTD is a conditional obligation arising in response to a violation, where a violation is signalled by an unfulfilled obligation. This type of construction identifies situations that are not ideal for the interaction but still acceptable for it. The ability to deal with violations or potential violations and the reparational obligation generated from them is one of the essential requirements for agents where, to the nature of the environment where they are deployed, some failures can occur, but where it does not necessarily mean that the whole interaction has to fail.

We represent the norms an agent has to comply as rules, where a rule is an expression:
r: A₁, . . . , Aₙ [symbol] B,
   where r is the (unique) name of the rule, A₁, . . . , Aₙ are the premises (propositions in the logic), B is the conclusion (also a proposition of the logic), and [symbol] indicates the rule is a defeasible rule. The propositions of the logic are built from a finite set of atomic propositions, and the following operators: [symbol] (negation), O (obligation), P (permission), and [symbol] (violation/reparation).

Given a rule r, A(r) denotes the set of premises of the rules, and C(r) for the conclusion. For a set of rules R, we use R[C] to denote the subset of R of rules where the conclusion is C. If p is an atomic proposition, then [symbol] p is a proposition. Given a proposition p we use ˜p to denote the complement of p: that is,
if p=l, then ˜p= [symbol] l and if p= [symbol] l, then ˜p=l.

If p is a proposition, then Op is an obligation proposition and Pp is a permission proposition. Both are called deontic propositions. If p₁, . . . , pₙ are obligation propositions and q is a deontic proposition, then p₁ [symbol] . . . [symbol] pₙ [symbol] q is a reparation chain. Given a reparation chain C, we use πᵢ(C) to denote the ith element of the chain; finally |C| returns the length of C, i.e., the number of elements in C.

A simple proposition corresponds to a factual statement. A reparation chain captures obligations and normative positions arising in response to violations of obligations. For example, B₁ [symbol] B₂ means that B₁ is the primary obligation and B₂ is the alternative “secondary” obligation. In other words, the process is obliged to perform B₁, and in case B₁ is not fulfilled (i.e., the obligation is violated), the alternative obligation B₂ must be fulfilled. While single obligations and permissions (and their negations) can appear in the premises of a rule, reparation chains can be used only in rule conclusions.

FCL is equipped with a superiority relation over the rule set. The superiority relation ( [symbol] ) determines the relative strength of two rules, and it is used when rules have potentially conflicting conclusions. For example, given the following rules
rule r₁: A [symbol] OB [symbol] OC and rule r₂: D [symbol] O [symbol] C,
   r₁ [symbol] r₂ means that rule r₁ prevails over rule r₂ in situation where both fire (active) and in conflict. In this case there is a conflict when rule r₁ fires for the secondary obligation OC.

The aim is to identify whether a given agent is compliant with a set of rules. This requires determination of obligations generated by the case data relevant for the agent in a particular interaction with other agents. To this end, the normalisation procedure of FCL (see [4]) that merges rules generating obligations with rules having the negation of the obligation in the premises (or so called CTD rules). For example, the rules below:
rule r₁: A [symbol] OB and rule r₂: C, [symbol] B [symbol] OD,
   can be merged into the rule A,C [symbol] OB [symbol] OD.

In addition the normalisation process uses a subsumption algorithm to remove redundant rules. At the end of the process the normalisation procedure generates a set of rule with all unique maximal reparation chains. The compliance checkers use the maximal chains to determine whether a task in a process and then a process itself complies with a given set of rules.

Besides the normalisation mechanism FCL has a second reasoning mechanism to determine the set of conclusions (obligations, permissions, prohibitions and reparation chains) in force for a specific case. Since FCL is an extension of defeasible logic with the reparation operator ( [symbol] ), the reasoning mechanism to derive conclusion is an extension of that for defeasible logic.

To derive a conclusion, let us say A, compliance engine 116 scans the set of rules 122 for a rule having A in its conclusion, and the rule should be applicable. This means that all literals in the antecedent of the rule are either facts or are already provable.

Defeasible logic is a skeptical non-monotonic formalism, in that it does not support conflicting conclusions. Therefore, when rules creation engine 112 wants to prove a conclusion A then, it is necessary to ensure that all ‘reasons’ for [symbol] A (i.e. the opposite of A) are not usable to prevent the conclusion of A.

Thus, for all rules having [symbol] A in the conclusions compliance engine 116 has to check that either the rules do not fire (that is at least one of the premises do not hold) or the rule for [symbol] A is weaker than an applicable for A. In defeasible logic, the conclusions of a rule is a single literal and not a reparation chain. Thus, the condition that A appears in the conclusion of a rule means that A is the conclusion of the rule.

For FCL, this notion is extended to accommodate reparation chain. The required change is that to prove A, all rules with a reparation chain for A need to be considered, where for all elements before A in the chain, the negation of the element is already provable (The full algorithm is given in reference [3]). Thus, to prove A given:
Rule: P₁, . . . , Pₙ [symbol] C₁ [symbol] . . . [symbol] Cₘ [symbol] A [symbol] D₁ [symbol] . . . [symbol] Dₖ, P₁, . . . , Pₙ must be provable, and [symbol] C₁, . . . , [symbol] Cₘ must also be provable.

### Compliance Checking

FCL constraint expressions for a set of rules define a behavioural and state space which can be used to analyse how well different behaviour execution paths (including state constraints) comply with the FCL constraints. This analysis is used as a basis for deciding whether the execution of an interaction among agents is compliant with the rules expressed in FCL.

Compliance checking involves determining whether a situation is ideal, sub-ideal, non-ideal or irrelevant with respect to a rule (norm):

(a) Ideal situation, where execution paths do not violate FCL expressions, and thus the execution paths (which will then correspond to processes that are related to the norms describing the expected behaviour of the agents) are fully compliant with the norms.

(b) Sub-ideal situation, where there are some violations, but these are repaired, in the CTD sense. Accordingly, processes resulting in sub-ideal situations are still compliant to a contract even if they provide non-optimal performances of the norms.

(c) Non-ideal situation, where some norms are violated and the violations are not repaired. In this case, a process resulting in a non-ideal situation does not comply with the norms describing the expected behaviour.

(d) Irrelevant situation, where the situation is irrelevant for a set of norms if no rule is applicable in the situation. Irrelevant situations correspond to states of affairs where the set of norms is silent about them.

There are two possible reasons for a process or situation to not to comply with the rules. Firstly, the process executes some tasks which are prohibited by the norms or equivalently, it executes the opposite of obligatory tasks. Secondly, the process fails to execute some tasks required by the norms.

Given a set of rules prescribing the behaviour of an agent, compliance engine 116 computes the normal form of the set, where the normal form contains all conditions that can be derived from the rules and redundant clauses are removed. Thus, normal forms allow the compliance engine 116 to determine whether the actual behaviours of an agent conform with expected behaviours described by a set of rules, and therefore to calculate a degree of compliance of the agent.

The determination of whether a situation is either ideal, sub-ideal, non-ideal or irrelevant with respect to a single rule (norm) is based on the following definition.

Definition 1 (Single Rule): With respect to a rule Γ [symbol] A₁ [symbol] . . . [symbol] Aₙ, where Γ is the set of premises of the rule

(a) A situation S is ideal if and only if the primary obligation A₁ is satisfied, i.e.

Γ∪{A₁}⊂S.

(b) A situation S is sub-ideal if and only if the primary obligation is violated, but the rule allows for reparation and a non-primary obligation is satisfied, i.e.

Γ∪{Aᵢ}⊂S,

if for some 1<i≦n such that ∀Aⱼ, j<i, A₁ . . . , Aⱼ∉S.

(c) A situation S is non-ideal if and only if none of A₁ to Aₙ is satisfied and
Γ⊂S, but S is neither ideal nor sub-ideal.

(d) A situation S is irrelevant if and only if it is neither ideal nor sub-ideal nor non-ideal. In this case, the rule is not applicable.

Definition 1 is concerned with the status of a situation with respect to a single rule, while the behaviour of an agent, typically, is described/regulated by many rules. This is extended to cover the case of a set of rules, where all rules in the normal form for the set of rules governing the expected behaviour of an agent:

### Definition 2 (Normal Form):

(a) A situation S is ideal with respect to an FCL normal form if and only if there is no rule in the normal form for which S is either sub-ideal or non-ideal or irrelevant.

(b) A situation S is sub-ideal with respect to an FCL normal form if and only if there is a rule for which S is not irrelevant and it is sub-ideal, and there is no norm in the normal form for which S is non-ideal.

(c) A situation S is non-ideal with respect to a FCL normal form if and only if there is no rule in the normal form for which S is not irrelevant and is non-ideal.

(d) A situation S is irrelevant with respect to an FCL normal form if and only if for all rules in the normal form S is irrelevant.

Definition 2 follows immediately from the interpretation we have provided in Definition 1. On the other hand, the relation between a normal form and the set of rules from which it is obtained seems to be a more delicate matter. A careful analysis of the conditions for constructing an FCL normal form allows us to state the following general criterion:

### Definition 3 (General Criterion):

A situation S is ideal (sub-ideal, non-ideal, irrelevant) with respect to a set of FCL rules if S is ideal (sub-ideal, non-ideal, irrelevant) with respect to the normal form of the set of FCL rules.

It is worth noting that Definition 3 shows the relevance of the distinction between a set of rules and its normal form. This holds in particular for the case of sub-ideal situations.

Suppose you have the following set of FCL rules:

rule r₁: [symbol] OA (i.e. A is obligatory), and
rule r₂: [symbol] A [symbol] OB (i.e. if A is not satisfied, B is obligatory),
   the corresponding normal form is: [symbol] OA [symbol] OB.

While the situation with [symbol] A and B is sub-ideal with respect to the latter, it would be non-ideal for the former. In the first case, even if there is the rule [symbol] A [symbol] OB, this expresses an implicit reparational obligation of the rule [symbol] OA. The key point here is that there was no link between the primary and reparation obligations in the original set of rules, but this is made explicit in the normal form.

Therefore, there exists a situation which apparently accomplishes a rule and violates the other without satisfying any reparation. This conclusion cannot be accepted because it is in contrast with our intuition according to which the presence of two rules such as [symbol] OA and [symbol] B [symbol] OB must lead to a unique rule. For this reason, we can evaluate a situation as sub-ideal with respect to a set of FCL rules only if it is sub-ideal with respect to its normal form.

Given a set of rules R and a set of literals S (plain literals and deontic literals), the compliance engine 116 uses the inference mechanism of defeasible logic to compute the set of conclusions (obligations) in force given the set of literals. These are the obligations an agent has to obey to in the situation described by the set of literals. However, the situation could already be a sub-ideal situation, i.e., some of the obligations prescribed by the rules are already violated. Thus, given a set of literals describing a state-of-affairs the compliance engine 116 computes not only the current obligations, but also what reparation chains are in force given the set.

Consider a scenario where the situation is described by A and [symbol] B, and the rules are:
rule r₁: A [symbol] OB (i.e. B is obligatory)
rule r₂: [symbol] B [symbol] OC (i.e. if B is not satisfied, C is obligatory),
   the corresponding normal form is:
normal form: A [symbol] OB [symbol] OC (i.e. B is a primary obligation and C is an alternative expected behaviour).

Since we have a violation of the first rule r₁ (A [symbol] OB and [symbol] B), then it is not possible to have an ideal situation here because the primary obligation B is not satisfied. In this case, the chains that are active for the ideal situation have to be identified.

Definition 4: A reparation chain C is active given a set of literals S, if

1. ∃r∈R[C]: ∀aᵣ∈A(r), aᵣ∈S and
2. ∀s∈R[D] such that π₁ (C)∈D, either
(i) ∃aₛ∉A(s): ˜aₛ∉S or
(ii) ∃i πᵢ(D)=˜π₁(C) and ∀k, k<i, ˜πₖ(D) ∉S
(iii) ∃t∈R[E]: πⱼ(E)=π₁(C), ∀aₜ∈A(t), aₜ∈S, ∀m, m<j, ˜πₘ(E)∉S and t>s.

Let us examine the following example. Consider the following rules:
rule r₁: A₁ [symbol] OB [symbol] OC (i.e. B is a primary obligation, and C is secondary)
rule r₂: A₂ [symbol] O [symbol] B [symbol] OD (i.e. [symbol] B is a primary obligation, and D is secondary)
rule r₃: A₃ [symbol] OE [symbol] O [symbol] B (i.e. E is a primary obligation, and [symbol] B is secondary)

If the situation S is described by literals A₁ and A₃, the active chains are OB [symbol] OC and OE [symbol] O [symbol] B. The chain OB [symbol] OC is active because rule r₂ cannot be used to activate the chain O [symbol] B [symbol] OD. For rule r₃ and the resulting chain OE [symbol] O [symbol] B, there is no violation of the primary obligation OE of the rule because [symbol] E is not one of the literals in S. Therefore, the resulting obligation O [symbol] B is not entailed by rule r₃.

According to Definition 4, given a set of literals (actual behaviours monitored by the monitoring engine 114) each active chain is uniquely determined by a rule in the set of rules 122. Therefore we can identify an active chain with the rule from which the chain is obtained.

### Degree of Compliance

Compliance distance is measured to indicate the degree of match between a the set of rules describing the expected behaviour of an agent for a particular type of interaction, and the actual behaviour in an instance of an interaction of the given type. The degree of compliance is a numerical value between 0 and 1 that measures how distant is the actual behaviour of a particular instance of an interaction by an agent from the expected behaviour.

Given a set of rules R describing the expected behaviour of an agent and a set of literals F (corresponding to the case data describing the actual behaviours of an agent), the compliance engine 116 determines C, the set of the reparation chains relevant with respect to the case data. The algorithm performed by the compliance engine 116 is as follows.

Compliance Calculation Algorithm

```
Input:
    F: set of literals (actual behaviours) and
    C: set of rules (expected behaviours)
Output:
    d ∈ [0;1]: degree of compliance
For each chain c ∈ C
    let i ∈ [symbol] : πᵢ(c) ∈ F and ∀ j < i : πⱼ(c) ∉ F
    $the distance is \text{:} d ( c ) = \frac{1 + \vert c \vert - i}{\vert c \vert}$
    $and the overall ( normalised ) distance is \text{:} d = \frac{{\sum }_{c ε C} d ( c )}{\vert C \vert} .$
```

In the above algorithm, the degree of compliance is calculated as the ratio between the number of fulfilled obligations and the total number obligation in force for a transaction. First of all, given a scenario for an agent, we consider only the reparation chains that are relevant to the particular behaviour of the agent. Then for every relevant chain we identify whether the situation (identified by the case data) is ideal, sub-ideal or non-ideal.

Every ideal situation is compliant, the agent did what it was expected to do, and only one obligation (the primary obligation, the most preferred outcome) was in force for that reparation chain. Thus the execution get a score of 1 for every chain for which the situation is ideal. For chains, for which the situation is sub-ideal, the degree of compliance is between 0 and 1.

For example, consider the following chains c₁, c₂, c₃∈C, obtained from a set of rules 122 according to the procedure given in Definition 4, and set of literals (actual behaviours monitored by the monitoring engine 114) F:
rule c₁: OA [symbol] OB [symbol] OC
rule c₂: OD [symbol] OE [symbol] OF
rule c₃: OG [symbol] OH
set of literals F: A, B, [symbol] D, E and [symbol] H.

The algorithm is performed by the compliance engine 116 using the following steps.

Step 1: Match the actual behaviours with the expected behaviours in the first rule. In this case, actual behaviours A and B are matched with the expected behaviours in rule c₁ and the primary obligation A of rule c₁ is satisfied. Therefore, the degree of compliance for rule c₁ is:

d(c₁)=1.

Step 2: Match the actual behaviours with the expected behaviours in the second rule. In this case, actual behaviours [symbol] D and E are matched with the expected behaviours in rule c₂, but the primary obligation D is violated because D∉F but the secondary or alternative obligation E is fulfilled (i=2). Therefore, the degree of compliance for rule c₂ is:

d(c₂)=(1+3−2)/3=2/3.

Step 3: Match the actual behaviours with the expected behaviours in the third rule. In this case, actual [symbol] H behaviour is matched with the expected behaviours in rule c₃. However, neither the primary obligation G is fulfilled nor the violation is compensated by the secondary obligation H. Therefore, the degree of compliance for rule c₃ is:

d(c₃)=0.

Step 4: Lastly, based on the calculated values, calculate the overall degree of compliance based on the respective degree of compliance of rules c₁, c₂, c₃ as:

d=(d(c₁)+d(c₂)+d(c₃))/3=(1+2/3+0)/3=0.56.

### Other Factors

The Compliance Calculation Algorithm performed by the compliance engine 116 can be updated to consider other factors, such as the following.

### (1) Weighting of Each Rule

Weights are used to reflect the different importance and influences of the various trust factors. A weight may be attached to a single rule, in which case the degree of compliance can be calculated as:

$$d = \frac{{\sum }_{c ∈ C} w ( c ) d ( c )}{\vert C \vert}$$

where w(c) is the weight attached to each rule. A weight may also be attached to a single parameter inside a rule. For example, rule c₁ in the previous example can be updated to:
rule c₁: O(w₁A) [symbol] O(w₂B) [symbol] O(w₃C)

And then the compliance distance is given by the formula

$$d ( c ) = ( \frac{1 + \vert c \vert - i}{\vert c \vert} ) \times {w}_{i}$$

The set of rules can be divided into a plurality of, possibly overlapping, subsets, each subset representing a particular metric that contributes to the overall degree of compliance. For example, a subset of rules can describe expected behaviours in terms of responsiveness, reliability and timeliness. In this case, a weighting factor can be attached to a particular subset, or a rule in the subset.

### (2) Historical Performance

The history of interactions between agents can be used to improve the calculation of degree of compliance as it gives more relevance to trends of behaviours. In this case, the degree of compliance can be calculated as follows:

$$d = w\_history ( d\_history ) + ( 1 - w\_history ) \frac{{\sum }_{c ∈ C} w ( c ) d ( c )}{\vert C \vert}$$

where d_history indicates the historical degree of compliance based on past actual behaviour, and w_history is the weight associated with that value. Parameter w_history can be set to less than 0.5 to give more weight to the most recent degree of compliance. Of course, w_history can also vary according to the rules.

### (3) Weighting of Each Agent

A weight may be attached to the feedback received from an agent. A more reputable agent (as indicated by their overall degree of compliance) would have a higher weighting than a new user with lower overall degree of compliance.

Similarly, a minimum degree of compliance can be set for a new user. For an existing user, their degree of compliance can be set to at least the minimum degree of compliance of a new user.

### Example 1

### Interactions between Human Agents

In a centralised trust/reputation model such as the eBay model [8], buyers place bids to buy from a seller. The buyer is obliged to pay the agreed amount and the seller is responsible for shipment of the good in agreed time frame and also for accurateness of the advertised good. The buyer and the seller can report to a central authority operated by an e-commerce trading server 150 about their interaction as ‘not delivered in time’ or ‘check bounced’; see FIG. 1. The central authority 150 calculates these feedbacks and combines with the history of the buyer and the seller and calculates the reputation. The reputation is then available for future buyers or sellers. Subjectivity lies in the feedback that users can send to the central authority, which is either Positive, Negative, Neutral or None.

To remove subjectivity using the invention, the central authority 150 should have access to the rules 122 between the buyer and seller in the data store 120, which describe the expected behaviours of both parties for their interactions during the transaction. For example, the rules 122 are:
rule r₁ (for seller): Paid [symbol] ODeliverylnTime [symbol] OCashBack
rule r₂ (for seller): Paid [symbol] OMatchAdvertisedProperties [symbol] OCashBack
rule r₃ (for buyer): WillingtoPay [symbol] OPayByCheque [symbol] OMoneyOrder

The first two rules show the seller's obligation in the interaction. According to first rule, if the buyer has paid, the buyer must receive the good within the agreed delivery time. Otherwise, the seller should return the money. The second rule requires the seller to deliver the exact product that she has advertised. Otherwise she should return the payment from the buyer. The third rule requires the buyer who has won a bid to be willing to pay by cheque. Otherwise, if this obligation is not fulfilled, such as if the cheque bounces, then the payment must be made by money order.

During the transaction, the monitoring engine 114 monitors the actual behaviour of both the buyer and seller. The actual behaviour, as represented by literals, will then be used by the compliance engine 116 to calculate the degree of compliance of the seller and of the buyer. For example, the following literals are collected:
DeliverylnTime, [symbol] MatchAdvertisedProperties, CashBack.

Using the compliance calculation algorithm explained in the previous section, the compliance engine 116 calculates the degree of compliance of the seller as follows.

Step 1: For rule r₁, d(r₁)=1 because primary obligation DeliveryInTime is satisfied.
Step 2: For rule r₂, d(r₂)=0.5 because reparation obligation CashBack is satisfied when primary obligation MatchAdvertisedProperties is not.
Step 3: The degree of compliance of the seller is d=(d(r₁)+d(r₂))/2=0.75.

Similarly, the compliance engine 116 automatically calculates the degree of compliance of the buyer using the same algorithm.

### Example 2

### Interactions Between Computer-Operated Agents

The invention can also be used to provide automated rating of web services in service composition in Service Oriented Architecture (SOA). In this case, the agents are computer agents in the form of web services. No manual user feedback provided in such cases, and performance can only be evaluated using transaction logs.

Using the rules creation engine 112, rules can be created to define expected behaviour or performance of a web service in terms of response time during peak and off pear hours, availability, service level agreement compliance (SLA) and maintenance period.

For example, the following rules can be used:
rule r₁: peakHour [symbol] O(responseTime<1 s) [symbol] O(responseTime<1.25 s)
rule r₂: offPeak [symbol] O(responseTime<0.5 s) [symbol] O(responseTime<0.75 s)
rule r₃: [symbol] O(available) [symbol] O(notify)
rule r₄: maintenance [symbol] O(downtime<1 h)
rule r₅: maintenance [symbol] [symbol] [symbol] available
rule r₆: available [symbol] O(success>90%) [symbol] O(discount) O(refund)
rule r₇: [symbol] SLAcompliance [symbol] O(discount) [symbol] P(refund)

The first two rules require the average response time to be 1 second during peak hours and 0.5 second during off-peak hours, with a tolerance of 0.25 seconds in both cases. Rules 3 and 5 require the service to be available at all times unless downtime has been notified to the user. Rules 4 and 5 require the service downtime to be less than 1 hour. Rule 6 requires the service to commit to the success rate of 90%. Otherwise, the user obtains a discount of 50% of the normal price, or if the discount is not possible, the user can get a refund. The last rule requires that if the service does not satisfy the service specifications, the user gets a discount. If the discount is not possible, the user is entitled to get a refund.

Similarly, the monitoring engine 114 will monitor the actual behaviours of the web service. This may be performed in real time, or at a later stage based on the event transaction logs recorded by the web service.

Based on the monitored actual behaviours, the compliance engine 116 then calculates the degree of compliance of the web service using the previously explained compliance calculation algorithm.

It should be understood that the techniques of the present invention might be implemented using a variety of technologies. For example, although the “engines” have been illustrated as hardware boxes in FIG. 1, the “engines” can be implemented in its entirety using software running on a general purpose computer or a dedicated server as shown.

It should also be understood that the methods performed by the “engines” described herein may be implemented by a series of computer executable instructions residing on a suitable computer readable medium. Suitable computer readable media may include volatile (e.g. RAM) and/or non-volatile (e.g. ROM, disk) memory, carrier waves and transmission media (e.g. copper wire, coaxial cable, fibre optic media). Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “processing” or “computing” or “calculating” or “determining” or “monitoring” or “displaying” or “matching” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

### Variations

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

At least one embodiment of the invention can be used to minimise the degree of subjectivity in decentralised systems. Examples of such systems are reputation management system, regret trust model and referral system.

In a reputation management system [7], a group of broker agents collect interaction reports and generates the reputation measure for other agents. The reputation rᵢ of an agent aᵢ is calculated as:

$${r}_{i} = \frac{{\sum }_{j = 1}^{k} {report}_{j}}{N}$$

where reportⱼ is generated by the other agents about agent aᵢ. Each report reportⱼ can take value either 0 or 1. So ‘subjectivity’ is introduced in this model as interaction can be mapped to two predefined values (0 for noncompliance and 1 for compliance). In this model, agents' interactions are modelled using the Prisoner Dilemma where players use pure strategies.

Using at least one embodiment of the invention, subjectivity can be minimised by setting rules that define the expected behaviour of the agents. Their actual behaviour, as indicated by adherence to these rules, will objectively determine the actual reputation.

In a Regret trust model [9], agents keep the record of their interactions as they maintain rating of agents in a database. The database is queried to calculate the trust. Each rating is associated with a weight, which depends on the recency of the rating. In this model, outcome(O) is defined as dialogue between the agents which reflects either negotiation to establish a contract between them or a course of actions taken by agents with some initial contracts. The reputation/trust of an agent is computed based on the ‘impression’ the agent made on other agents in previous interaction. The impression is modelled as tuple Impression=(a,b,O,χ,t,W) where a, b are agents (a is judging b's impression), O is outcome, c is the variable that is ‘topic’ of interaction between agents a and b, and W is a rating b by a that is between −1 and 1.

Using at least one embodiment of the invention, outcome O corresponds to agents actual behaviour and variable c corresponds to the expected behaviour on an agent. The compliance calculation algorithm can be used to calculate rating W based on the actual and expected behaviour.

In referral systems [10,11], agents keep track of agents they know and their expertise.

An agent can query its known agents about information. If these agents could not answer the query, they will refer to some other agents who may answer. The idea of these referral systems is that when agent aᵢ evaluates reputation of agent aⱼ, aᵢ will use results of its direct interaction with aⱼ and other agents' recommendation about aⱼ. The direct interactions with aⱼ are represented as Sⱼ₁, Sⱼ₂, . . . S_{jH} (last H interactions) and Sⱼₖ∈[0, 1], k≦H.

Using at least one embodiment of the invention, the exact mapping of Sⱼₖ to [0,1] can be defined using rules, and calculated based on actual behaviour of the agents.

Finally, in a reputation system that allows combination of different information sources such as direct interaction, witness report and third party references [6], the direct interaction between two agents a and b, a's rating about agent b is represented as:

r=(a,b,c,i,v)

where i is the interaction between agents, v is the rating which takes a value in terms of c, c can have values as [quality, honesty] and v has value in the range [−1, +1].

Using at least one embodiment of the invention, the trust reputation of an agent can be modelled using a vector of values where each value represents a parameter of interest for agent interactions. A set of rules can be defined for each parameter, thereby determining the degree of compliance v for each parameter.

What is claimed is:

1. A computer system for rating agents participating in electronic transactions, the system comprising:
a data store to store a set of rules to describe expected behaviours of a first agent for interactions that take place during an electronic transaction with a second agent, wherein at least one rule describes the expected behaviours in terms of a primary expected behaviour;
a monitoring engine operable to monitor actual behaviours of the first agent for interactions that take place during the electronic transaction; and
a compliance engine operable to calculate a degree of compliance between the monitored actual behaviours and the expected behaviours.

2. The computer system of claim 1, wherein there is at least one rule describes the expected behaviours in terms of a primary expected behaviour and at least one alternative expected behaviour.

3. The computer system of claim 2 wherein there are two rules each with at least one expected behaviour that are merged to the corresponding normal form.

4. The computer system of claim 1, wherein the compliance engine is further operable to match a monitored actual behaviour with a primary or alternative expected behaviour described by one of the rules.

5. The computer system of claim 4, wherein the compliance engine is further operable to calculate the degree of compliance based on the distance of the matched expected behaviour from the primary expected behaviour.

6. The computer system of claim 1, wherein the expected behaviours are described using defeasible logic and deontic operators.

7. The computer system of claim 6, wherein the expected behaviours are described as either obligatory, permissible or forbidden using deontic operators.

8. The computer system of claim 1, wherein at least one rule in the set is associated with a weighting factor, and the degree of compliance is calculated based on the weighting factor of the at least one rule.

9. The computer system of claim 1, wherein the set of rules are divided into a plurality of subsets, each subset representing a metric that contributes to the calculation of the degree of compliance.

10. The computer system of claim 1, wherein the expected behaviours described in the rule are associated with a weighting factor, and the degree of compliance is calculated based on the weighting factor of the expected behaviours.

11. The computer system of claim 1, wherein the degree of compliance between the monitored actual behaviours and the expected behaviours is also based on historical performance of the agent.

12. The computer system of claim 1, wherein the monitoring engine is operable to monitor actual behaviours of the first agent based on log files recorded during the electronic transaction.

13. The computer system of claim 1, wherein the monitoring engine is operable to monitor actual behaviours of the first agent based on input from the second agent.

14. The computer system of claim 1, wherein the electronic transaction is an electronic commerce transaction between the agents.

15. The computer system of claim 1, wherein the electronic transaction is a web service interaction between the agents.

16. The computer system of claim 1, wherein at least one of the first and second agents is computer-operated.

17. The computer system of claim 1, further comprising a rules creation engine to provide an interface for agents to define the set of rules prior to an electronic transaction.

18. The computer system of claim 1, wherein the set of rules are created by domain experts prior to the electronic transaction.

19. A computer-implemented method for rating agents participating in electronic transactions, the method comprising:
monitoring actual behaviours of the first agent for interactions that place during the electronic transaction; and
calculating a degree of compliance between the monitored actual behaviours and expected behaviours of a first agent for interactions that take place during an electronic transaction with a second agent,
wherein the expected behaviours are described using a set of rules, and wherein at least one rule describes the expected behaviours in terms of a primary expected behaviour.
